(19) United States
(12) Patent Application Publication
(10) Pub. No.: US 2022/0197947 A1
(43) Pub. Date: Jun. 23, 2022

(54) VISUAL COMPLEXITY SLIDER FOR PROCESS GRAPHS

(71) Applicant: UiPath, Inc., New York, NY (US)

(72) Inventor: Roeland Johannus SCHEEPENS, Eindhoven (NL)

(73) Assignee: UiPath, Inc., New York, NY (US)

(21) Appl. No.: 17/129,856

(22) Filed: Dec. 21, 2020

(51) Int. Cl. G06F 16/901; G06F 16/9035; G06F 3/02

(52) U.S. Cl. CPC G06F 16/9024; G06F 3/02; G06F 16/9035

(57) ABSTRACT

Systems and methods for filtering a process graph are provided. Paths in a process graph representing execution of a process are identified. A measure of importance is calculated for each of the identified paths. The identified paths are sorted based on the calculated measures of importance. The process graph is filtered according to a level of complexity based on the sorted identified paths. The filtered process graph is output.

### TECHNICAL FIELD

The present invention relates generally to process mining, and more particularly to a visual complexity slider for filtering process graphs according to a level of complexity.

### BACKGROUND

Processes are sequences of activities executed by one or more computers to provide various services. The execution of a process may be represented as a process graph, where each activity is represented as a node and each execution between activities is represented as an edge linking nodes. At times, the process graph may comprise a large number of nodes and edges. Conventionally, such a process graph would be displayed to a user with all edges and nodes, which may result in visual overload to the user.

### BRIEF SUMMARY OF THE INVENTION

In accordance with one or more embodiments, a visual complexity slider is provided to filter a process graph in accordance with a level of complexity to facilitate the presentation of the process graph to a user. Advantageously, the filtering of the process graph in accordance with the level of complexity enables presentation of the most important nodes and edges of the process graph while not visually overloading the user.

In one embodiment, systems and methods for filtering a process graph are provided. Paths in a process graph representing execution of a process are identified. A measure of importance is calculated for each of the identified paths. The identified paths are sorted based on the calculated measures of importance. The process graph is filtered according to a level of complexity based on the sorted identified paths. The filtered process graph is output. The process may be an RPA (robotic process automation) process.

In one embodiment, the level of complexity is defined based on user input received via a slider. In another embodiment, the level of complexity is automatically determined by identifying a smallest set of the sorted identified paths, starting at a top of the sorted identified paths, with a combined number of edges greater than a predetermined minimal number of edges and adding each next respective path to the identified set until either 1) the measure of importance of the next respective path is less than a measure of importance of a first path of the sorted identified paths multiplied by a predetermined importance factor or 2) a combined number of edges will exceed a predetermined maximal number of edges if the next respective path is added.

In one embodiment, the paths in the process graph are identified by iteratively traversing each untraversed edge in the process graph with a highest frequency of execution until an end node of the process graph is reached or a previously traversed node of the process graph is reached and, for each respective iteration, identifying the untraversed edges, traversed during the respective iteration, as a path.

In one embodiment, the measure of importance for each of the identified paths are calculated based on frequencies of execution of edges of each of the identified paths. For example, the measures of importance for each of the identified paths may be calculated as a sum of the frequencies of execution of edges of each of the identified paths.

In one embodiment, the identified paths are sorted in descending order based on the calculated measures of importance.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process graph, in accordance with one or more embodiments of the invention;

FIG. 2 shows a method for filtering a process graph in accordance with a level of complexity, in accordance with one or more embodiments;

FIG. 3 shows an illustrative user interface of a process graph filtered based on a level of complexity defined based on user input received via a slider, in accordance with one or more embodiments;

FIG. 4 shows an illustrative user interface of a process graph filtered based on an automatically determined level of complexity, in accordance with one or more embodiments; and

FIG. 5 is a block diagram of a computing system according to an embodiment of the invention.

### DETAILED DESCRIPTION

A process may be executed by one or more computers to provide services for a number of different applications, such as, e.g., administrative applications (e.g., onboarding a new employee), procure-to-pay applications (e.g., purchasing, invoice management, and facilitating payment), and information technology applications (e.g., ticketing systems). In one embodiment, the process may be an RPA (robotic process automation) process automatically executed by one or more RPA robots. The execution of a process may be recorded in the form of an event log. To facilitate user understanding of the execution of the process, a process graph of the process may be generated based on the event log. The process graph is a visual representation of the execution of process.

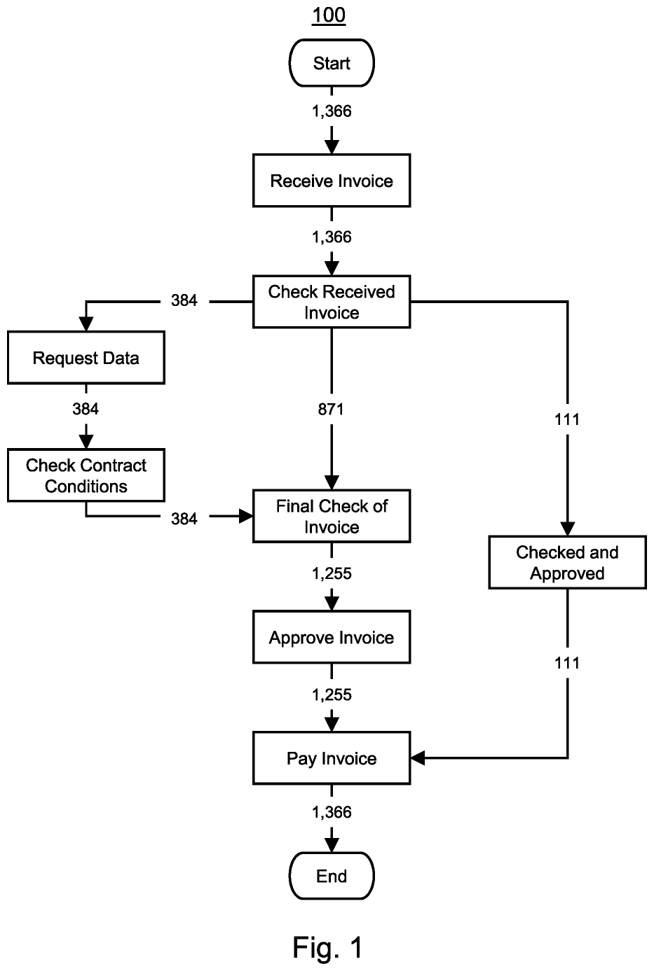

FIG. 1 shows an illustrative process graph 100. Process graph 100 represents execution of a process for processing an invoice. As shown in FIG. 1, process graph 100 is modelled as a directed graph where each activity of the process is represented as a node and the execution of the process from a source activity to a destination activity is represented as an edge connecting the nodes representing the source activity and the destination activity. Each edge in process graph 100 is associated with a number representing a frequency of execution of that edge. Process graph 100 may be presented to a user to facilitate understanding of the execution of the process to thereby enable the user to perform various process mining tasks, such as, identifying bottlenecks in the process, etc.

Often times, process graphs may comprise a large number of nodes and edges. Such a large number of nodes and edges in a process graph may result in visual overload when presented to the user, thereby preventing the user from understanding the process graph and thus the execution of the underlying process.

In accordance with embodiments described herein, a visual complexity slider is provided for filtering process graphs (e.g., process graph 100). The visual complexity slider defines a level of complexity at which process graph 100 should be filtered. By filtering process graph 100 in accordance with the visual complexity slider, the most important nodes and edges of process 100 is presented to a user in a manner that will not visually overload the user.

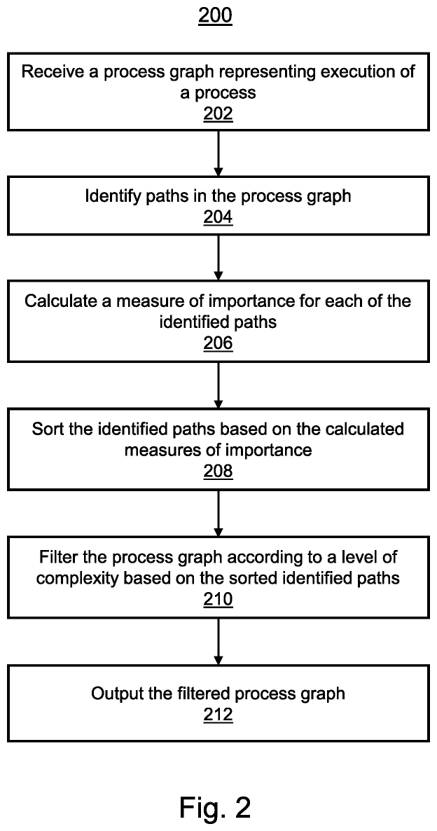

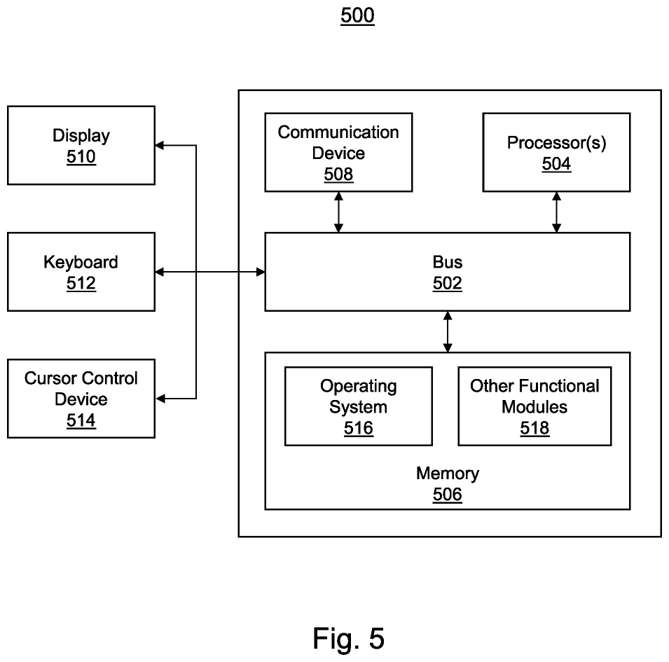

FIG. 2 shows a method 200 for filtering a process graph in accordance with a level of complexity, in accordance with one or more embodiments. Method 200 will be described with continued reference to process graph 100 of FIG. 1. The steps of method 200 may be performed by any suitable computing device, such as, e.g., computing system 500 of FIG. 5.

At step 202, a process graph representing execution of a process is received. In one example, the process graph is process graph 100 of FIG. 1. In one embodiment, the process graph represents execution of an RPA process automatically executed by one or more RPA robots. The process graph may be received by loading the process graph from a storage or memory of a computer system or receiving a process graph that has been transmitted from a remote computer system.

At step 204, paths in the process graph are identified. Each path represents a unique sequence of edges in the process graph. The paths may be identified using a greedy depth-first search approach. In one embodiment, the paths are identified by iteratively traversing the process graph. For each respective iteration of the traversal of the process graph, beginning at the start node and traversing the process graph towards the end node, each untraversed edge with a highest frequency of execution is traversed until either the end node of the process graph is reached or a previously traversed node of the process graph is reached. The path is identified as a sequence of the untraversed edges that were traversed during the respective iteration. The process graph is iteratively traversed to identify paths until all edges and nodes of the process graph have been traversed. Other approaches for identifying paths in the process graph are also contemplated.

In one example, the paths are identified as the sequence of edges connecting the following nodes in process graph 100 of FIG. 1:
Path 1: <Start, Receive Invoice, Check Received Invoice, Final Check of Invoice, Approve Invoice, Pay Invoice, End>;
Path 2: <Check Received Invoice, Request Data, Check Contract Conditions, Final Check on Invoice>; and
Path 3: <Check Received Invoice, Checked and Approved, Pay Invoice>.

At step 206, a measure of importance is calculated for each of the identified paths. In one embodiment, the measure of importance of a respective path is calculated based on the frequencies of execution of each edge in the respective path. In one example, the measure of importance may be calculated as the sum of the frequencies of execution of each edge in the respective path. For instance, the measure of importance of path 1 of process graph 100 of FIG. 1 is 1,366+1,366+871+1,255+1,255+1,366=7,479, the measure of importance of path 2 is 384+384+384=1,152, and the measure of importance of path 3 is 111+111=222. The measure of importance may be any other suitable measure, such as, e.g., an average of the frequencies of execution of each edge in the respective path, a median of the frequencies of execution of each edge in the respective path, a mode of the frequencies of execution of each edge in the respective path, etc.

At step 208, the identified paths are sorted based on the calculated measures of importance. In one embodiment, the paths are sorted in descending order starting with a path with a highest calculated measure of importance to a path with a lowest calculated measure of importance. For example, the paths of process graph 100 of FIG. 1 are sorted in descending order as follows: Path 1, Path 2, and Path 3. In almost all cases, the first path of the sorted identified paths is the path starting at the start node and ending at the end node. Other approaches for sorting the identified paths may also be employed.

At step 210, the process graph is filtered according to a level of complexity based on the sorted identified paths. In one embodiment, the level of complexity may be defined between a range of 0 and (Number of Identified Paths−1). Accordingly, a level of complexity having a value n will filter the process graph to show only the first n+1 paths of the sorted identified paths. For example, for process graph 100 of FIG. 1, a level of complexity of n=0 would filter process graph 100 to show only Path 1 (and not Path 2 or Path 3), a level of complexity of n=1 would filter process graph 100 to show only Path 1 and Path 2 (and not Path 3), and a level of complexity of n=2 would filter process 100 to show all of Path 1, Path 2, and Path 3. The level of complexity may be defined in any other suitable form, such as, e.g., as a percentage between 0% and 100%.

In one embodiment, the level of complexity may be user defined based on user input. The user input may be received in any suitable manner. In one embodiment, the user input may be received via a visual complexity slider displayed to the user. The visual complexity slider may represent percentages ranging from 0% to 100%. Alternatively, the visual complexity slider may represent values of the level of complexity ranging from 0 to (Number of Identified Paths−1). A user may interact with the visual complexity slider by moving or sliding the visual complexity slider to a value according to a desired level of complexity. In another embodiment, the user input may be received by a user directly inputting the value of the level of complexity.

In one embodiment, the level of complexity may be automatically determined. The level of complexity may be automatically determined based on the following predefined parameters: a minimal number of edges eₘᵢₙ, a maximal number of edges eₘₐₓ, and an importance factor φ. First, starting at the top of the sorted identified paths, a smallest set of the sorted identified paths is identified that has a combined number of unique edges greater than eₘᵢₙ. That is, the first x sorted paths with a combined number of unique edges greater than eₘᵢₙ are identified. Second, each next respective path p′ of the sorted identified paths is added to the identified set until either: 1) the measure of importance of the next respective path I(p′) is less than the measure of importance of the first path of the sorted identified paths I(p₀) multiplied by the importance factor φ, i.e., I(p′)<φI(p₀), or 2) the combined number of unique edges will exceed eₘₐₓ if the next respective path p′ is added. Based on this approach, the level of complexity may be automatically determined each time a new process graph is rendered (e.g., after changing a filter). In one embodiment, the user may select an option to automatically determine the level of complexity and may deactivate the automatic determination of the level of complexity by defining the level of complexity.

At step 212, the filtered process graph is output. The filtered process graph may be output by, for example, displaying the filtered process graph on a display device of a computer system, storing the filtered process graph on a memory or storage of a computer system, or by transmitting the filtered process graph to a remote computer system.

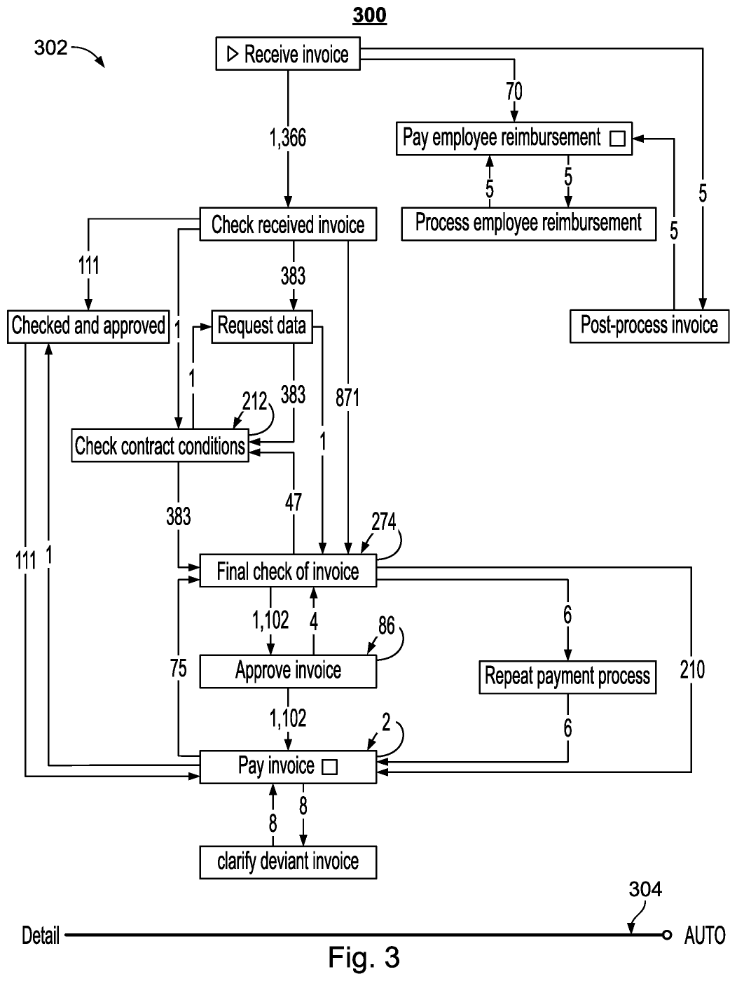

FIG. 3 shows an illustrative user interface 300 of a process graph 302, in accordance with one or more embodiments. User interface 300 comprises a visual complexity slider 304 to enable a user to define the level of complexity for filtering the process graph 302. Visual complexity slider 304 is set to 100% by a user in user interface 300 to show all nodes and edges of process graph 302 (i.e., no filtering). As shown in user interface 300, the large number of nodes and edges of process graph 302 makes the process graph difficult to interpret and understand due to visual overload.

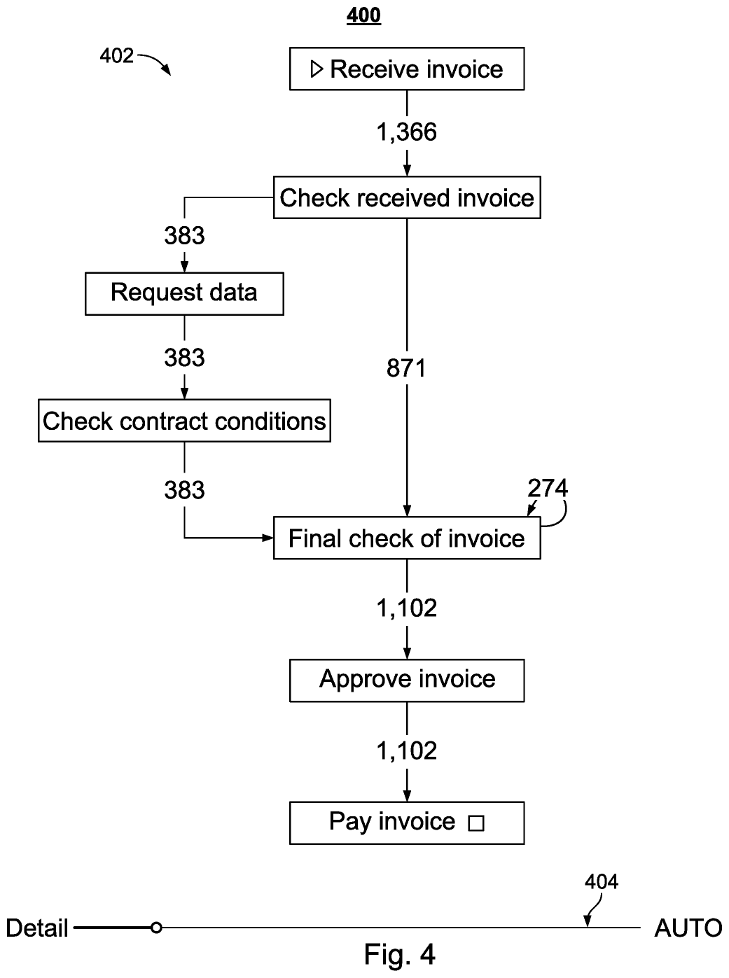

FIG. 4 shows an illustrative user interface 400 of a process graph 402, in accordance with one or more embodiments. Process graph 402 is process graph 302 of FIG. 3 filtered according to an automatically determined level of complexity. User interface 400 comprises a visual complexity slider 404 set to automatically determine the level of complexity. As shown in FIG. 4, process graph 402 is more comprehensible and understandable than process graph 302 of FIG. 3 while still including the most important nodes and edges.

FIG. 5 is a block diagram illustrating a computing system 500 configured to execute the methods, workflows, and processes described herein, including FIG. 2, according to an embodiment of the present invention. In some embodiments, computing system 500 may be one or more of the computing systems depicted and/or described herein. Computing system 500 includes a bus 502 or other communication mechanism for communicating information, and processor(s) 504 coupled to bus 502 for processing information. Processor(s) 504 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 504 may also have multiple processing cores, and at least some of the cores may be configured to perform specific functions. Multi-parallel processing may be used in some embodiments.

Computing system 500 further includes a memory 506 for storing information and instructions to be executed by processor(s) 504. Memory 506 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 504 and may include volatile media, non-volatile media, or both. The media may also be removable, non-removable, or both.

Additionally, computing system 500 includes a communication device 508, such as a transceiver, to provide access to a communications network via a wireless and/or wired connection according to any currently existing or future-implemented communications standard and/or protocol.

Processor(s) 504 are further coupled via bus 502 to a display 510 that is suitable for displaying information to a user. Display 510 may also be configured as a touch display and/or any suitable haptic I/O device.

A keyboard 512 and a cursor control device 514, such as a computer mouse, a touchpad, etc., are further coupled to bus 502 to enable a user to interface with computing system. However, in certain embodiments, a physical keyboard and mouse may not be present, and the user may interact with the device solely through display 510 and/or a touchpad (not shown). Any type and combination of input devices may be used as a matter of design choice. In certain embodiments, no physical input device and/or display is present. For instance, the user may interact with computing system 500 remotely via another computing system in communication therewith, or computing system 500 may operate autonomously.

Memory 506 stores software modules that provide functionality when executed by processor(s) 504. The modules include an operating system 516 for computing system 500 and one or more additional functional modules 518 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer implemented method comprising:
identifying paths in a process graph representing execution of a process;
calculating a measure of importance for each of the identified paths;
sorting the identified paths based on the calculated measures of importance;
filtering the process graph according to a level of complexity based on the sorted identified paths; and
outputting the filtered process graph.

2. The computer implemented method of claim 1, wherein the level of complexity is defined based on user input received via a slider.

3. The computer implemented method of claim 1, further comprising automatically determining the level of complexity by:
identifying a smallest set of the sorted identified paths, starting at a top of the sorted identified paths, with a combined number of edges greater than a predetermined minimal number of edges; and
adding each next respective path to the identified set until either 1) the measure of importance of the next respective path is less than a measure of importance of a first path of the sorted identified paths multiplied by a predetermined importance factor or 2) a combined number of edges will exceed a predetermined maximal number of edges if the next respective path is added.

4. The computer implemented method of claim 1, wherein filtering the process graph according to a level of complexity based on the sorted identified paths comprises:
filtering the process graph to show top paths of the sorted identified paths, wherein the top paths are determined based on the level of complexity.

5. The computer implemented method of claim 1, wherein identifying paths in a process graph representing execution of a process:
iteratively traversing each untraversed edge in the process graph with a highest frequency of execution until an end node of the process graph is reached or a previously traversed node of the process graph is reached; and
for each respective iteration, identifying the untraversed edges, traversed during the respective iteration, as a path.

6. The computer implemented method of claim 1, wherein calculating a measure of importance for each of the identified paths comprises:
calculating the measure of importance for each of the identified paths based on frequencies of execution of edges of each of the identified paths.

7. The computer implemented method of claim 6, wherein calculating the measure of importance for each of the identified paths based on frequencies of execution of edges of each of the identified paths comprises:
calculating the measure of importance for each of the identified paths as a sum of the frequencies of execution of edges of each of the identified paths.

8. The computer implemented method of claim 1, wherein sorting the identified paths based on the calculated measures of importance comprises:
sorting the identified paths in descending order based on the calculated measures of importance.

9. The computer implemented method of claim 1, wherein the process is an RPA (robotic process automation) process.

10. An apparatus comprising:
a memory storing computer instructions; and
at least one processor configured to execute the computer instructions, the computer instructions configured to cause the at least one processor to perform operations of:
identifying paths in a process graph representing execution of a process;
calculating a measure of importance for each of the identified paths;
sorting the identified paths based on the calculated measures of importance;
filtering the process graph according to a level of complexity based on the sorted identified paths; and
outputting the filtered process graph.

11. The apparatus of claim 10, wherein the level of complexity is defined based on user input received via a slider.

12. The apparatus of claim 10, the operations further comprising automatically determining the level of complexity by:
identifying a smallest set of the sorted identified paths, starting at a top of the sorted identified paths, with a combined number of edges greater than a predetermined minimal number of edges; and
adding each next respective path to the identified set until either 1) the measure of importance of the next respective path is less than a measure of importance of a first path of the sorted identified paths multiplied by a predetermined importance factor or 2) a combined number of edges will exceed a predetermined maximal number of edges if the next respective path is added.

13. The apparatus of claim 10, wherein filtering the process graph according to a level of complexity based on the sorted identified paths comprises:
filtering the process graph to show top paths of the sorted identified paths, wherein the top paths are determined based on the level of complexity.

14. The apparatus of claim 10, wherein identifying paths in a process graph representing execution of a process:
iteratively traversing each untraversed edge in the process graph with a highest frequency of execution until an end node of the process graph is reached or a previously traversed node of the process graph is reached; and
for each respective iteration, identifying the untraversed edges, traversed during the respective iteration, as a path.

15. A computer program embodied on a non-transitory computer-readable medium, the computer program configured to cause at least one processor to perform operations comprising:
identifying paths in a process graph representing execution of a process;
calculating a measure of importance for each of the identified paths;
sorting the identified paths based on the calculated measures of importance;
filtering the process graph according to a level of complexity based on the sorted identified paths; and
outputting the filtered process graph.

16. The computer program of claim 15, wherein the level of complexity is defined based on user input received via a slider.

17. The computer program of claim 15, wherein calculating a measure of importance for each of the identified paths comprises:
calculating the measure of importance for each of the identified paths based on frequencies of execution of edges of each of the identified paths.

18. The computer program of claim 17, wherein calculating the measure of importance for each of the identified paths based on frequencies of execution of edges of each of the identified paths comprises:
calculating the measure of importance for each of the identified paths as a sum of the frequencies of execution of edges of each of the identified paths.

19. The computer program of claim 15, wherein sorting the identified paths based on the calculated measures of importance comprises:
sorting the identified paths in descending order based on the calculated measures of importance.

20. The computer program of claim 15, wherein the process is an RPA (robotic process automation) process.
